(19) United States
(12) Patent Application Publication
(10) Pub. No.: US 2013/0284876 A1
(43) Pub. Date: Oct. 31, 2013

(54) ANTENNA HOLDING DEVICE FOR ELECTROMAGNETIC MEASURING

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: YONG-SHENG YANG, Shenzhen (CN)

(73) Assignees: Hon Hai Precision Industry Co., Ltd., New Taipei (TW); Hong Fu Jin Precision Industry (ShenZhen) Co., Ltd., Shenzhen (CN)

(21) Appl. No.: 13/730,722

(22) Filed: Dec. 28, 2012

(30) Foreign Application Priority Data
Apr. 26, 2012 (CN) 201220182369.5

(51) Int. Cl. F16M 11/20; H01Q 1/12

(52) U.S. Cl. CPC F16M 11/20; H01Q 1/125
USPC 248/519

(57) ABSTRACT

An antenna holding device for holding test antennas includes a base, a sliding plate, a holding pole, a first driving unit and a second driving unit. The base defines two parallel linear sliding grooves. The sliding plate is attached to the base and is slidably engaged in the two parallel linear sliding grooves. The holding pole is perpendicularly mounted on the sliding plate. The first driving unit includes a sliding block and an antenna pole. The sliding block is slidably attached to the holding pole, and the antenna pole is mounted on the sliding block. The second driving unit is positioned on the base and drives the sliding plate to move relative to the base.

### BACKGROUND

1. Technical Field

The present disclosure relates to antenna holding devices, and particularly to an antenna holding device for electromagnetic measuring.

2. Description of Related Art

When making electromagnetic measurements, such as electromagnetic interference (EMI) measurements, a test antenna needs to be mounted on a predetermined measuring location relative to a tested product to transmit and/or receive test signals. Furthermore, many relevant parameters (e.g., heights, and distances) of the test antenna often need to be adjusted. A horizontal distance between the adjusted test antenna and the tested product is required to be very precise. However, frequently adjusting the test antenna easily changes the horizontal distance. This may cause a large error in the measurement.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is an exploded view of an antenna holding device, according to an exemplary embodiment.

FIG. 2 is an assembled schematic view of the antenna holding device shown in FIG. 1.

### DETAILED DESCRIPTION

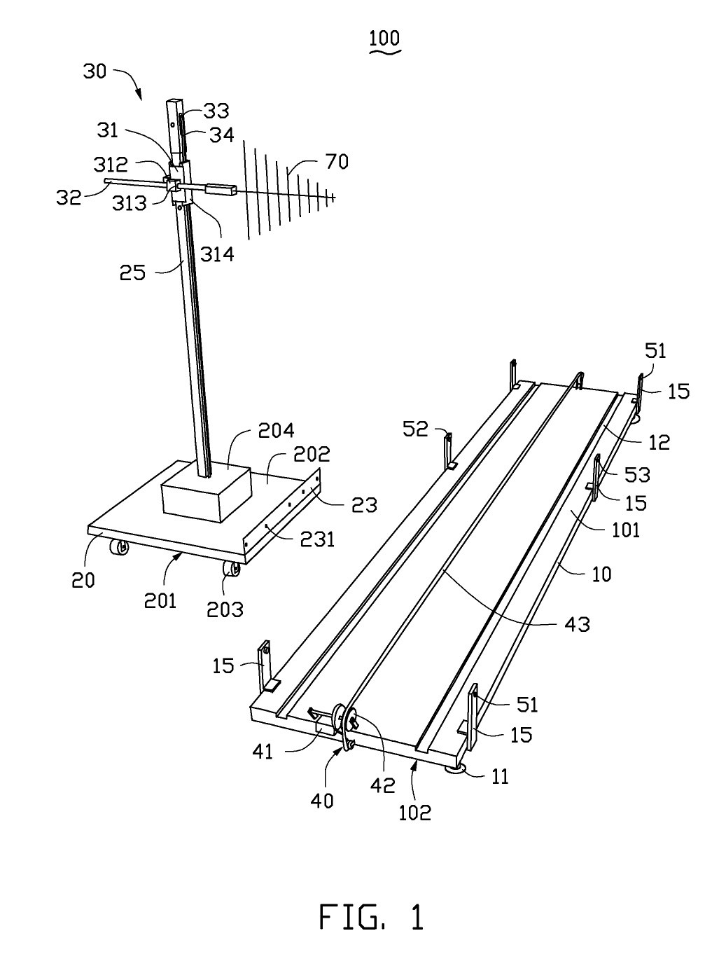

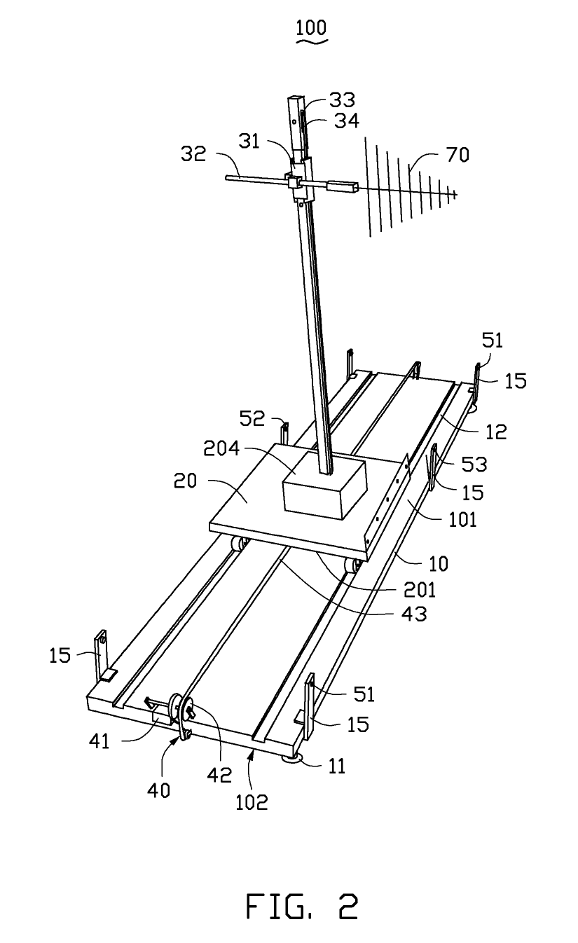

FIG. 1 and FIG. 2 show an antenna holding device 100, according to an exemplary embodiment. The antenna holding device 100 can be used to hold a test antenna for electromagnetic measurements, such as electromagnetic interference (EMI) measurements. In this embodiment, a test antenna 70 can be held on the antenna holding device 100.

The antenna holding device 100 comprises a base 10, a sliding plate 20, a holding pole 25, a first driving unit 30, a second driving unit 40, and a detection unit 50.

The base 10 is substantially a rectangular planar board, and comprises a top surface 101 and a bottom surface 102. The top surface 101 and the bottom surface 102 are parallel to each other. Four supporting feet 11 are respectively mounted on four corners of the bottom surface 102, for enabling the antenna holding device 100 to be horizontally positioned. A plurality of planar plates 15 are perpendicularly mounted on the top surface 101 of the base 10, and are all mounted on two long sides of the top surface 101, and are arranged in pairs. Two parallel linear sliding grooves 12 are defined in the top surface 101. The sliding plate 20, the holding pole 25, the first driving unit 30, the second driving unit 40, and the detection unit 50 are all mounted on and/or above the base 10.

The sliding plate 20 is substantially a rectangular planar board, and comprises a top surface 201 and a bottom surface 202. Four wheels 203 are rotatably mounted to the sliding plate 20 at the bottom surface 202. Each of the two sliding grooves 12 receives two of the four wheels 203, respectively. Pushing the sliding plate 20 along the sliding grooves 12 can drive the wheels 203 to rotate in the sliding grooves 12, and thereby slide the sliding plate 20 along the sliding grooves 12. A control box 204 is located on a center of the top surface 201. An extending plate 23 is mounted on a side of the top surface 202 of the sliding plate 20.

The holding pole 25 is positioned on a center of the control box 204. The control box 204 has a driving motor (not shown). The first driving unit 30 comprises a sliding block 31, an antenna pole 32, a driven wheel 33 and a first transmission belt 34. The sliding block 31 is slidably attached to the holding pole 25. The sliding block 31 comprises a knuckle 312, defining a through hole 313. The antenna pole 32 extends through the through hole 313 for mounting the antenna pole 32 on the sliding block 31. The driven wheel 33 is rotatably mounted to another end of the holding pole 25. The first transmission belt 34 is coiled around the driven wheel 33 and extends along the holding pole 25 until the first transmission belt 34 is fitted in the driving motor in the control box 204. A part of the first transmission belt 34 is mounted with the sliding block 31. When the first transmission belt 34 is driven by the driving motor to rotate around the driven wheel 33, the sliding block 31 can slide along the holding pole 25. The sliding block 31 further raises or lowers the antenna pole 32 for adjusting the height of the tested antenna 70.

The second driving unit 40 comprises a motor 41, two driving wheels 42 and a second transmission belt 43. The motor 41 is located at one end of the top surface 201 of the sliding plate 20. The two driving wheels 42 are located at opposite ends of the base 10. The second transmission belt 43 is coiled around the base 10, and one side of the second transmission belt 43 is fitted around the driving wheels 42. The sliding plate 20 is mounted on the second transmission belt 43. The motor 41 drives the driving wheels 42 to rotate, and further moves the second transmission belt 43 with the sliding plate 20.

The detection unit 50 comprises two pairs of infrared limit switches 51, a group of first infrared emitters 231, a second infrared emitter 52, and an infrared sensor 53. The infrared limit switches 51 are positioned on the planar plates 15 at opposite ends of the base 10. Each pair of infrared limit switches 51 are electronically connected to the motor 41. If the pair of infrared limit switches 51 are aligned to each other without the sliding plate 20, the infrared limit switches 51 are not activated. If the pair of infrared limit switches 51 are blocked by the sliding plate 20, the limit switches 51 can send a signal to stop the motor 41.

The group of the first infrared emitters 231 is arranged on the extending plate 23 along a horizontal straight line and equidistantly spaced from each other. The second infrared emitter 52 and the infrared sensor 53 are mounted on the planar plate 15 between the limit switches 51. The second infrared emitter 52 is mounted on the planar plate 15 of the top surface 101 at one side of the base 10 and is aligned with the infrared sensor 53 mounted on the planar plate 15 of the top surface 101 at the other side, correspondingly. When the sliding plate 20 slides along the sliding grooves 12, the first infrared emitters 231 can thus be driven to orderly shield the second infrared emitter 52 from the infrared sensor 53, and the first infrared emitters 231 can be orderly aligned with the infrared sensor 53.

Thus, the antenna holding device 100 having the test antenna positioned therein is positioned in an electromagnetic field in which EMI needs to be tested. The test antenna is electrically connected to a common processor (not shown), such as a personal computer (PC) or a single chip computer. The sliding plate 20 is manually pushed or driven by the motor 41 to slide along the sliding grooves 12, and thus drives the test antenna to be horizontally moved to the predetermined test positions. Thus, the processor can transmit and receive wireless signals via the test antenna, and thereby perform electromagnetic measurements.

The infrared limit switches 51, the first infrared emitters 231, the second infrared emitter 52 and the sensor 53 can also be electrically connected to the processor for enabling the processor to detect the position of the sliding plate 20 relative to the base 10. When the sliding plate 20 blocks one pair of infrared limit switches 51, the limit switches 51 can send a stop signal to stop the motor 41. The second infrared emitter 52 transmits infrared light to the infrared sensor 53, and the infrared sensor 53 generates a first detection signal in response to receiving the infrared light from the second infrared emitter 52 and transmits the first detection signal to the processor.

Furthermore, when the extending plate 23 shields the second infrared emitter 52, the group of the first infrared emitters 231 can be orderly aligned with the infrared sensor 53 during the movement of the sliding plate 20. Similarly, one of the first infrared emitters 231 can be aligned with the infrared sensor 53 after the sliding plate 20 has stopped moving. The infrared sensor 53 generates a second detection signal in response to receiving the infrared light from each of the first infrared emitters 231 and transmits the second detection signal to the processor. According to the number of times the second detection signals transmitted from the infrared sensor 53 are received by the processor, the processor can detect a moving distance of the sliding plate 20, and thereby further detect the position of the sliding plate 20 more accurately.

As detailed above, the height of the test antenna 70 can be adjusted by means of adjusting the total length of the holding pole 25, and the horizontal position of the test antenna can be adjusted. In other words, the height of the test antenna can be adjusted along a vertical axis, and the horizontal position of the test antenna can be adjusted along a horizontal axis, with the vertical and horizontal axes being perpendicular to each other. Therefore, the test antenna 70 being held by the antenna holding device 100 can be easily carried between different measuring locations and does not need to be frequently mounted on and removed from each measuring locations. Furthermore, relevant parameters of the test antenna, such as polarity, height, and horizontal position, can be easily adjusted according to the above-described methods.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An antenna holding device, for holding test antennas, comprising:
a base defining two parallel linear sliding grooves;
a sliding plate attached to the base and slidably engaged in the two parallel linear sliding grooves;
a holding pole perpendicularly mounted on the sliding plate;
a first driving unit positioned on the holding pole, the first driving unit comprising a sliding block and an antenna pole, the sliding block slidably attached to the holding pole, and the antenna pole mounted on the sliding block; and
a second driving unit positioned on the base driving the sliding plate to move relative to the base.

2. The antenna holding device as claimed in claim 1, wherein four wheels are rotatably mounted to the sliding plate at a bottom surface, each of the two parallel linear sliding grooves receive two of the four wheels, respectively.

3. The antenna holding device as claimed in claim 1, wherein the first driving unit comprises a driven wheel and a first transmission belt, the driven wheel is rotatably mounted to the holding pole, the first transmission belt is coiled around the driven wheel and extends along the holding pole, and a part of the first transmission belt is mounted with the sliding block configured for moving the sliding block.

4. The antenna holding device as claimed in claim 3, wherein the second driving unit comprises a motor, and two driving wheels and a second transmission belt; and the motor is located at one end of the sliding plate, the two driving wheels are located at opposite ends of the base, the second transmission belt is coiled around the base, and one side of the second transmission belt is fitted around the two driving wheels, and the sliding plate is mounted on the second transmission belt.

5. The antenna holding device as claimed in claim 1, wherein a plurality of planar plates are perpendicularly mounted on the base, and are arranged in pairs.

6. The antenna holding device as claimed in claim 5, further comprising a detection unit; wherein the detection unit comprises two pairs of infrared limit switches, and the infrared limit switches are positioned on the plurality of planar plates at opposite ends of the base.

7. The antenna holding device as claimed in claim 6, wherein the detection unit comprises a group of first infrared emitters, a second infrared emitter, and an infrared sensor, the first infrared emitters are arranged on the extending plate along a horizontal straight line and equidistantly spaced from each other, the second infrared emitter and the infrared sensor are mounted on one of the plurality of planar plates between the two pairs of the limit switches.
